(19) United States
(12) Patent Application Publication
(10) Pub. No.: US 2017/0352903 A1
(43) Pub. Date: Dec. 7, 2017

(54) FUEL CELL SYSTEM AND FAILURE DETERMINATION METHOD OF FUEL CELL SYSTEM

(71) Applicant: HONDA MOTOR CO., LTD., Tokyo (JP)

(72) Inventors: Yusai YOSHIMURA, Wako (JP); Satoru KAWASE, Wako (JP); Yuji MATSUMOTO, Wako (JP)

(73) Assignee: HONDA MOTOR CO., LTD., Tokyo (JP)

(21) Appl. No.: 15/597,153

(22) Filed: May 17, 2017

(30) Foreign Application Priority Data
Jun. 3, 2016 (JP) 2016-111960

(51) Int. Cl. H01M 8/04746; H01M 8/04082; H01M 8/04664; H01M 8/0438; H01M 8/1018

(52) U.S. Cl. CPC H01M 8/04753; H01M 8/04686; H01M 8/04388; H01M 8/04201; H01M 2008/1095; H01M 2250/20

(57) ABSTRACT

A fuel cell system includes first and second tanks, first and second pipes, a pipe, a first valve, a second valve, a pressure sensor, and circuitry. The first pipe is connected to the first tank. The second pipe is connected to the second tank. The pipe is connected to a fuel cell and connected to the first and second pipes to supply a reaction gas from the first and second tanks to the fuel cell. The first valve is provided at the first pipe. The second valve is provided at the second pipe. The pressure sensor is provided at the pipe between the joint point and the fuel cell. The circuitry determines whether a failure occurs in at least one of the first and second valves based on a change in the pressure detected by the pressure sensor while the first and second valves are controlled.

### CROSS-REFERENCE TO RELATED APPLICATIONS

The present application claims priority under 35 U.S.C. §119 to Japanese Patent Application No. 2016-111960, filed Jun. 3, 2016, entitled “Fuel Cell System and Failure Determination Method of Fuel Cell System.” The contents of this application are incorporated herein by reference in their entirety.

### BACKGROUND

### 1. Field

The present disclosure relates to a fuel cell system and a failure determination method of the fuel cell system.

### 2. Description of the Related Art

A fuel cell system of a fuel cell vehicle may be provided with a plurality of tanks that retain hydrogen gas in order to improve the load capacity of the hydrogen gas and install the fuel cell system in a limited space such as the inside of a vehicle body (see, for example, Japanese Unexamined Patent Application Publication No. 2013-253672).

Such a fuel cell system simultaneously opens on-off valves that are respectively connected to the plurality of tanks to flow out hydrogen gas, to cause the hydrogen gas to join in the course of a flow path unit, and to supply the joined hydrogen gas to the fuel cell, for the sake of simplification of a control. Moreover, the fuel cell system detects the pressure of the hydrogen gas by a pressure sensor, and calculates the remaining amount of the hydrogen gas and a driving range. In particular, the fuel cell system disclosed in Japanese Unexamined Patent Application Publication No. 2013-253672 achieves reduction in cost, reduction in weight, reduction in hydrogen leakage, and the like by providing one pressure sensor at the downstream side of a join point of the hydrogen gas.

### SUMMARY

According to a first aspect of the present invention, a fuel cell system includes a first tank, a first pipe, a second tank, a second pipe, a pipe, a first valve, a second valve, a pressure sensor, and circuitry. The first tank stores a reaction gas. The first pipe is connected to the first tank. The second tank stores the reaction gas. The second pipe is connected to the second tank. The pipe is connected to a fuel cell and connected to the first pipe and the second pipe at a joint point to supply the reaction gas from the first tank and the second tank to the fuel cell. The first valve is provided at the first pipe. The second valve is provided at the second pipe. The pressure sensor is provided at the pipe between the joint point and the fuel cell to detect a pressure of the reaction gas. The circuitry is configured to control the first valve and the second valve. The circuitry is configured to determine whether a failure occurs in at least one of the first valve and the second valve based on a change in the pressure detected by the pressure sensor while the first valve and the second valve are controlled.

According to a second aspect of the present invention, a failure determination method of a fuel cell system including a first tank to store a reaction gas, a first pipe connected to the first tank, a second tank to store the reaction gas, a second pipe connected to the second tank, a pipe connected to a fuel cell and connected to the first pipe and the second pipe at a joint point to supply the reaction gas from the first tank and the second tank to the fuel cell, a first valve provided at the first pipe, a second valve provided at the second pipe, and a pressure sensor provided at the pipe between the joint point and the fuel cell to detect a pressure of the reaction gas, the failure determination method includes controlling the first valve and the second valve. It is determined whether a failure occurs in at least one of the first valve and the second valve based on a change in the pressure detected by the pressure sensor while the first valve and the second valve are controlled.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an explanation view illustrating a connection state between tanks and a fuel cell in a fuel cell system according to one embodiment of the present disclosure.

FIG. 2 is a block diagram illustrating function units of a controller in FIG. 1.

FIG. 3A is an explanation view illustrating an operation of a failure determination control when first and second on-off valves are normal, and FIG. 3B is an explanation view illustrating an operation of the failure determination control when the second on-off valve has a failure.

FIG. 4 is an explanation view illustrating an operation of the failure determination control when the first on-off valve has a failure.

FIG. 5 is a flowchart illustrating a process flow of the failure determination control.

FIG. 6 is a time chart of the failure determination control when the first and second on-off valves are normal.

FIG. 7 is a time chart of the failure determination control when the second on-off valve has a failure.

FIG. 8 is a time chart of the failure determination control when the first on-off valve has a failure.

FIG. 9 is an explanation view illustrating an operation of a failure determination control of first to third on-off valves in a fuel cell system according to a modification example.

### DESCRIPTION OF THE EMBODIMENTS

The embodiments will now be described with reference to the accompanying drawings, wherein like reference numerals designate corresponding or identical elements throughout the various drawings.

The following describes in details preferred embodiments of a fuel cell system and a failure determination method of the fuel cell system according to the present disclosure with reference to the accompanying drawings.

A fuel cell system 10 according to the embodiment of the present disclosure is mounted on a fuel cell vehicle, for example, and is configured to supply power to loads of a drive source and the like. It should be noted that the fuel cell system 10 is not limited to for the in-vehicle use, but can be applied to for various usage purposes including a stationary use by being subjected to modifications as appropriate.

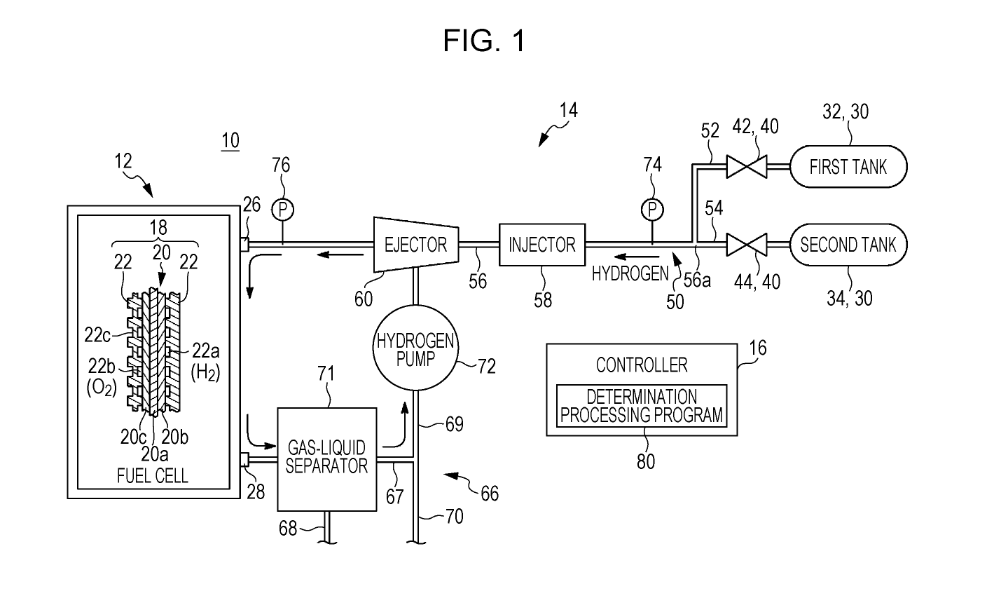

As illustrated in FIG. 1, the fuel cell system 10 is provided with a fuel cell 12 (fuel cell stack), a fuel gas supply device 14 that is connected to the fuel cell 12 and supplies a hydrogen gas (reaction gas) as a fuel gas thereto, and a controller 16 that is a system control device. Moreover, the fuel cell system 10 includes, as other configurations, which are not illustrated, an oxidant gas supply device that supplies air (reaction gas) as an oxidant gas, a coolant supply device that supplies a coolant, a battery that is an energy storage device, and others.

The fuel cell 12 is provided with a plurality of power generation cells 18 that are stacked in the horizontal direction or the vertical direction in the inside thereof, and generates power based on a chemical reaction between the hydrogen gas supplied from the fuel gas supply device 14 and the air supplied from the oxidant gas supply device. The power generation cells 18 include an electrolyte membrane-electrode assembly 20, and a pair of separators 22 that sandwich the electrolyte membrane-electrode assembly 20 therebetween.

The electrolyte membrane-electrode assembly 20 is provided with a solid polymer molecule electrolyte membrane 20a (PEM) that is a moisture-containing thin membrane of a perfluorosulfonic acid, and an anode electrode 20b and a cathode electrode 20c that sandwich the solid polymer molecule electrolyte membrane 20a therebetween, for example. A hydrocarbon (HC) based electrolyte, in addition to the fluorine type electrolyte, is used for the solid polymer molecule electrolyte membrane 20a.

The pair of the separators 22 respectively form a hydrogen gas flow path 22a for supplying the hydrogen gas to the anode electrode 20b and an air flow path 22b for supplying the air to the cathode electrode 20c, between each separator 22 and the electrolyte membrane-electrode assembly 20. A coolant flow path 22c that circulates a coolant is provided between the separators 22 to be adjacent to each other because the power generation cells 18 are stacked.

The fuel cell 12 includes a hydrogen gas inlet 26 and a hydrogen gas outlet 28. The hydrogen gas inlet 26 penetrates in the stacked direction of the respective power generation cells 18, and communicates with the hydrogen gas flow path 22a at the supply side. The hydrogen gas outlet 28 penetrates in the stacked direction of the respective power generation cells 18, and communicates with the hydrogen gas flow path 22a at the discharge side. Although the illustration is omitted, the fuel cell 12 is provided with an air inlet and an air outlet that cause the oxidant gas supply device to communicate with the air flow path 22b, and includes a coolant inlet and a coolant outlet that cause the coolant supply device to communicate with the coolant flow path 22c.

The fuel gas supply device 14 is provided with a plurality (two in the present embodiment) of tanks 30 that store therein high-pressure hydrogen gas. The plurality of the tanks 30 constitute a hydrogen supply source that supplies the hydrogen gas to the fuel cell 12, and are provided by being distributed in a limited space inside a vehicle body of a fuel cell vehicle, thereby preventing a design change of the vehicle body and improving the load capacity of the hydrogen gas. For example, the plurality of tanks 30 includes a first tank 32 (main tank) that is provided under a load-carrying platform at a rear side of the vehicle body, and into which a large amount of hydrogen gas can be filled, and a second tank 34 (sub-tank) that is provided at the lower side of a seat or at the front side of the vehicle body, and into which a small amount of hydrogen gas can be filled. It should be noted that the volumetric capacity of each tank 30 is not specially limited as a matter of course, for example, the volumetric capacity of the second tank 34 may be larger than that of the first tank 32.

The first and the second tanks 32 and 34 communicate with the hydrogen gas inlet 26 of the fuel cell 12 through a hydrogen gas supply pipe 50 (flow path unit). The hydrogen gas supply pipe 50 includes a first pipe 52 that is connected to the first tank 32, and a second pipe 54 that is connected to the second tank 34. The first pipe 52 and the second pipe 54 are respectively connected to a join point 56a that is one end portion of a junction pipe 56, and the junction pipe 56 is continuous to the fuel cell 12 from the join point 56a.

Moreover, the plurality of tanks 30 are respectively provided with on-off valves 40 that interrupt or allow the outflow of the hydrogen gas, at connection points with the hydrogen gas supply pipe 50. Specifically, a first on-off valve 42 is provided at a connection point between the first tank 32 and the first pipe 52. Similarly, a second on-off valve 44 is provided at a connection point between the second tank 34 and the second pipe 54. For example, an electromagnetic valve that opens a flow path in the pipe in response to an open command Cₒ by the controller 16 and closes the flow path in the pipe in response to a close command Cc by the controller 16 is applied to each of the first and the second on-off valves 42 and 44, which are connected to the controller 16 so as to allow information communication. It should be noted that the first and the second on-off valves 42 and 44 may be independently and respectively provided to the first pipe 52 and the second pipe 54, as different components from the plurality of tanks 30. Moreover, the first and the second on-off valves 42 and 44 may be valve mechanisms that are opened and closed due to a manual operation by a user of the fuel cell vehicle.

An injector 58 and an ejector 60 are provided in series to the junction pipe 56 of the hydrogen gas supply pipe 50. The injector 58 is used for injecting the hydrogen gas to the downstream side when power is normally generated. The ejector 60 to which a hydrogen circulation pipe 69, which is described later, is connected guides the hydrogen gas flowing through the junction pipe 56 to the fuel cell 12, while joining a part of a hydrogen exhaust gas (hydrogen gas) that is discharged from the fuel cell 12 to the junction pipe 56.

Moreover, the fuel gas supply device 14 includes a hydrogen gas discharge mechanism 66 that derives the hydrogen exhaust gas (hydrogen gas used in the anode electrode 20b) from the fuel cell 12 and is connected to the hydrogen gas outlet 28 of the fuel cell 12. The hydrogen gas discharge mechanism 66 is provided with a hydrogen gas discharge pipe 67, a drain pipe 68, the hydrogen circulation pipe 69, a purge pipe 70, a gas-liquid separator 71, and a hydrogen pump 72.

The hydrogen gas discharge pipe 67 includes the gas-liquid separator 71 at a halfway position thereof, and the gas-liquid separator 71 separates a fluid mainly including a liquid component from the hydrogen exhaust gas and discharges the fluid from the drain pipe 68 that is connected to a bottom portion of the gas-liquid separator 71. Moreover, the hydrogen gas discharge pipe 67 branches into the hydrogen circulation pipe 69 and the purge pipe 70 at the downstream side of the gas-liquid separator 71. The hydrogen circulation pipe 69 includes the hydrogen pump 72 at a halfway position thereof, and the hydrogen pump 72 circulates the hydrogen exhaust gas to the ejector 60 of the junction pipe 56 through the hydrogen circulation pipe 69. Moreover, the purge pipe 70 discharges the hydrogen exhaust gas from the fuel cell system 10.

Moreover, provided to the junction pipe 56 at the upstream side of the injector 58 is a pressure sensor 74 that detects the pressure of the hydrogen gas supplied from the first and the second tanks 32 and 34. The pressure sensor 74 is connected to the controller 16 so as to allow information communication, and transmits a detection signal S of the pressure detected in the junction pipe 56 to the controller 16. A sensor unit that can detect the high-pressure gas is applied to the pressure sensor 74 so as to cope with the hydrogen gas supply pipe 50 that causes the high-pressure hydrogen gas to flow, and the sensor unit is hermetically fixed into the flow path of the junction pipe 56.

Although the illustration is omitted, the hydrogen gas supply pipe 50 may be provided with a regulator that regulates the pressure of the hydrogen gas in the junction pipe 56 at the downstream side of the pressure sensor 74. In addition, the hydrogen gas supply pipe 50 may be provided with a pressure sensor 76 in the junction pipe 56 at a position near the upstream of the fuel cell 12. This enables the fuel cell system 10 to detect the pressure of the hydrogen gas immediately before being supplied to the fuel cell 12, and use the pressure in the control by the controller 16.

The controller 16 of the fuel cell system 10 drives the fuel cell system 10 to control the power generation in the fuel cell 12. The controller 16 is configured as a well-known computer (including a micro controller) that is provided with an input-output interface, a processor, a memory, and others, which are not illustrated. The memory of the controller 16 stores therein a determination processing program 80 for performing determination processing on a failure of each of the on-off valves 40 of the plurality of tanks 30.

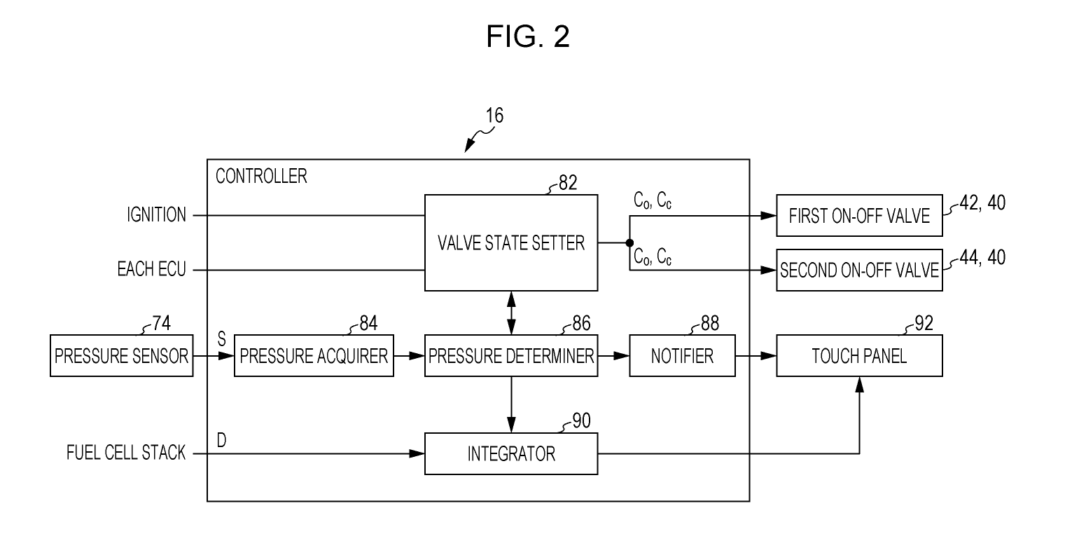

The controller 16 executes the determination processing program 80 by the processor to perform a failure determination control in which the pressure sensor 74 detects the pressure in the junction pipe 56, and failures of the first and the second on-off valves 42 and 44 are determined while switching between opening and closing of the first and the second on-off valves 42 and 44. Specifically, as illustrated in FIG. 2, the controller 16 is functioned as a valve state setter 82, a pressure acquirer 84, a pressure determiner 86, a notifier 88, and an integrator 90.

The valve state setter 82 outputs the open command Cₒ and the close command C_{c} to each of the first and the second on-off valves 42 and 44 to switch between opening and closing of each the first and the second on-off valves 42 and 44, when the failure determination control is executed. The valve state setter 82 simultaneously or individually outputs the open command Cₒ or the close command C_{c} to the first and the second on-off valves 42 and 44 in accordance with the timing. For example, the valve state setter 82 starts an operation using an ignition ON operation by the user or an operation instruction from another ECU as a trigger, or causes the first and the second on-off valves 42 and 44 to open and close by monitoring the timing of determination by the pressure determiner 86. In addition, the valve state setter 82 also notifies the pressure determiner 86 of states of opening or closing in the first and the second on-off valves 42 and 44.

The pressure acquirer 84 acquires (receives and stores in a memory) the pressure in the junction pipe 56 detected by the pressure sensor 74, in other words, the pressure of the hydrogen gas supplied from the first and the second tanks 32 and 34.

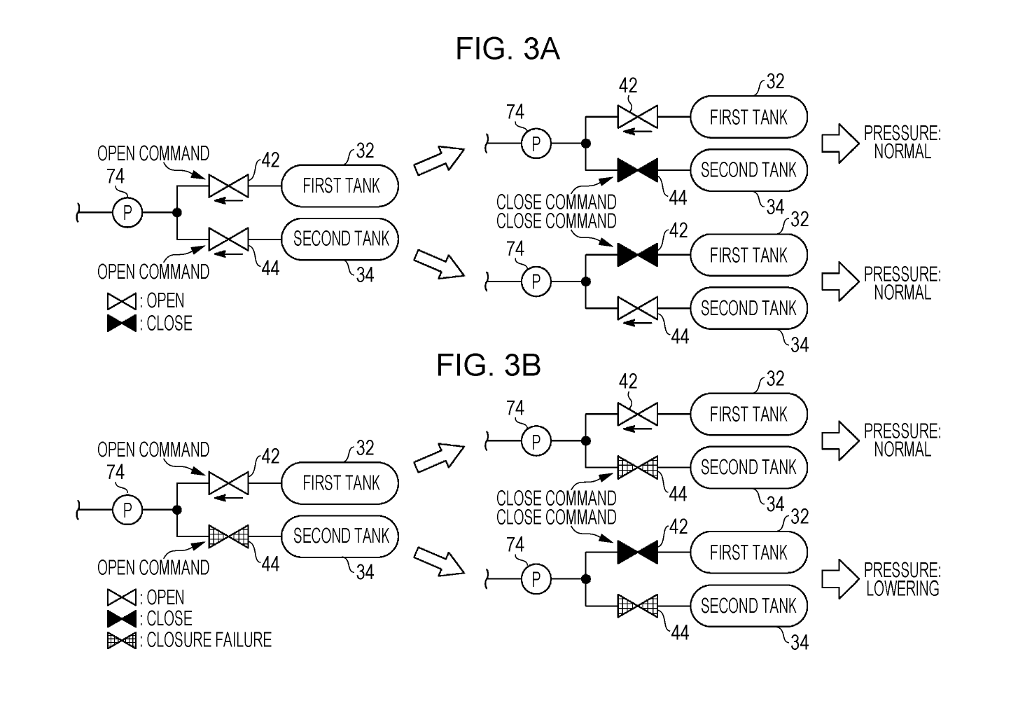

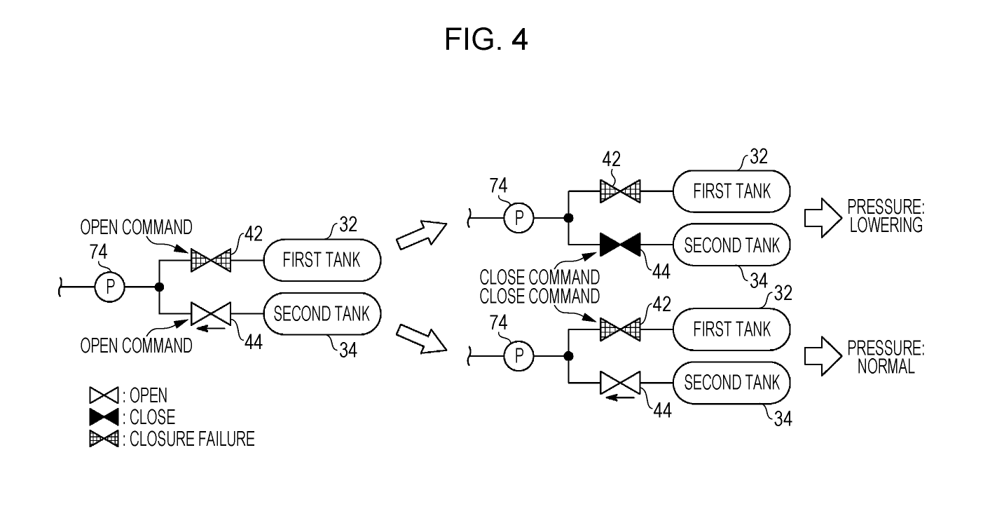

The pressure determiner 86 determines failures of the first and the second on-off valves 42 and 44 based on the states of the first and the second on-off valves 42 and 44 notified by the valve state setter 82 and the pressure acquired by the pressure acquirer 84. Hereinafter, with reference to FIGS. 3A to 4, the principle of determination on failures of the first and the second on-off valves 42 and 44 will be described. It should be noted that in FIGS. 3A to 4, an outlined on-off valve 40 indicates an opened state, a solid black on-off valve 40 indicates a closed state, and a hatched on-off valve 40 indicates a state of closure failure.

As illustrated in FIG. 3A, when the first and the second on-off valves 42 and 44 have no closure failure, open commands Cₒ are outputted to the first and the second on-off valves 42 and 44 to cause the hydrogen gas to flow out from both of the first and the second tanks 32 and 34. Here, the closure failure indicates a case where the on-off valve 40 is not opened but is fixed in a closed state, so that no hydrogen gas is discharged from the tank 30. In this case, the hydrogen gas in the first pipe 52 and the hydrogen gas in the second pipe 54 are joined at the join point 56a, the joined hydrogen gas flows through the junction pipe 56, and the pressure thereof is detected by the pressure sensor 74. Moreover, the hydrogen gas supplied to the fuel cell 12 without any change is used for power generation, so that the hydrogen gas is continuously supplied from each of the plurality of tanks 30.

Further, when the first and the second on-off valves 42 and 44 have no closure failure, if the second on-off valve 44 is closed, the hydrogen gas is stopped to be supplied from the second tank 34, but the hydrogen gas is supplied from the first tank 32. Accordingly, the pressure sensor 74 hardly detects the lowering of the pressure or detects the slight lowering of the pressure. The pressure determiner 86 can determine the normality of the first on-off valve 42 based on this detection. Similarly, if the first on-off valve 42 is closed, the hydrogen gas is stopped to be supplied from the first tank 32, but the hydrogen gas is supplied from the second tank 34. Accordingly, the pressure sensor 74 hardly detects the lowering of the pressure or detects the slight lowering of the pressure. The pressure determiner 86 can determine the normality of the second on-off valve 44 based on this detection.

Meanwhile, as illustrated in FIG. 3B, when the first on-off valve 42 has no closure failure and the second on-off valve 44 has a closure failure, open commands Cₒ are outputted to the first and the second on-off valves 42 and 44 to cause the hydrogen gas to be supplied only from the first tank 32.

In this case, if the second on-off valve 44 is closed, the hydrogen gas is continuously supplied from the first tank 32. Accordingly, the pressure sensor 74 hardly detects the lowering of the pressure, so that the pressure determiner 86 can determine the normality of the first on-off valve 42. In contrast, if the first on-off valve 42 is closed, the hydrogen gas supplied from the first and the second tanks 32 and 34 is stopped. Accordingly, the pressure sensor 74 detects the rapid lowering of the pressure in the junction pipe 56. This enables the pressure determiner 86 to determine the abnormality of the second on=off valve 44.

Alternatively, as illustrated in FIG. 4, when the first on-off valve 42 has a closure failure and the second on-off valve 44 has no closure failure, open commands Cₒ are outputted to the first and the second on-off valves 42 and 44 to cause the hydrogen gas to be supplied only from the second tank 34.

In this case, if the second on-off valve 44 is closed, the hydrogen gas supplied from the first and the second tanks 32 and 34 is stopped. Accordingly, the pressure sensor 74 detects the rapid lowering of the pressure in the junction pipe 56. This enables the pressure determiner 86 to determine the abnormality of the first on-off valve 42. In contrast, even if the first on-off valve 42 is closed, the hydrogen gas is continuously supplied from the second tank 34. Accordingly, the pressure sensor 74 hardly detects the lowering of the pressure, so that the pressure determiner 86 can determine the normality of the second on-off valve 44.

Referring back to FIG. 2, the notifier 88 of the controller 16 displays a determination result determined by the pressure determiner 86 on a touch panel 92 of the fuel cell vehicle. This enables the user of the fuel cell vehicle to easily recognize the poor supply of the hydrogen gas. It should be noted that a notifying device by the notifier 88 is not limited to the touch panel 92, but the notifier 88 may notify the user of the determination result with an indicator, a speaker, or the like, which is not illustrated, for example.

Moreover, when the first and the second tanks 32 and 34 have different degrees of importance, the fuel cell system 10 may preferably use different ways between when determining a closure failure of the first on-off valve 42 and when determining a closure failure of the second on-off valve 44.

For example, when the first tank 32 (the first on-off valve 42) having a large load capacity of hydrogen has a closure failure, the generation of power in the fuel cell 12 is covered with the supply of the hydrogen gas from the second tank 34, thereby generating a significant difference between a driving range that is calculated by the ECU based on the hydrogen gas and the range by the actual use of hydrogen gas. Therefore, when a closure failure of the first on-off valve 42 is determined in maintenance (service work) of the fuel gas supply device 14, a severe failure may be notified to the user with the touch panel 92 or the indicator, and the user may be prompted to stop the drive of the fuel cell vehicle or the like. Alternatively, under the circumstance other than the circumstance when the service work is performed, the consumption of the hydrogen gas largely varies depending on the load. Therefore, when a closure failure of the first on-off valve 42 is determined, the controller 16 may integrate a current value D of the fuel cell 12 by the integrator 90 to predict the lowering of the pressure (in other words, out of the hydrogen gas), and request the supply or the maintenance of the hydrogen gas at an early stage.

In contrast, in a case where the second tank 34 (the second on-off valve 44) having a small load capacity of hydrogen has a closure failure, the user is difficult to distinguish the case from the normal case due to the small influence. Moreover, the ECU calculates a driving range to be excessive to some extent, which is not largely different from the fluctuation of the fuel consumption when the vehicle is traveling, and it can be said that the excessive driving range can be handled before the hydrogen gas runs out of gas if the vehicle is travelling without coping with the excessive driving range. Therefore, a closure failure of the second on-off valve 44 is determined in the service work, the fuel cell vehicle is available for traveling by only notifying the touch panel 92 and the like of the failure of the second on-off valve 44. Moreover, under the circumstance other than the circumstance when the service work is performed, no special action is performed, for example, when the user concerns that the fuel consumption becomes worse and checks the state of the vehicle body by a trouble shooting or the like, the failure of the second on-off valve 44 may be notified to the user.

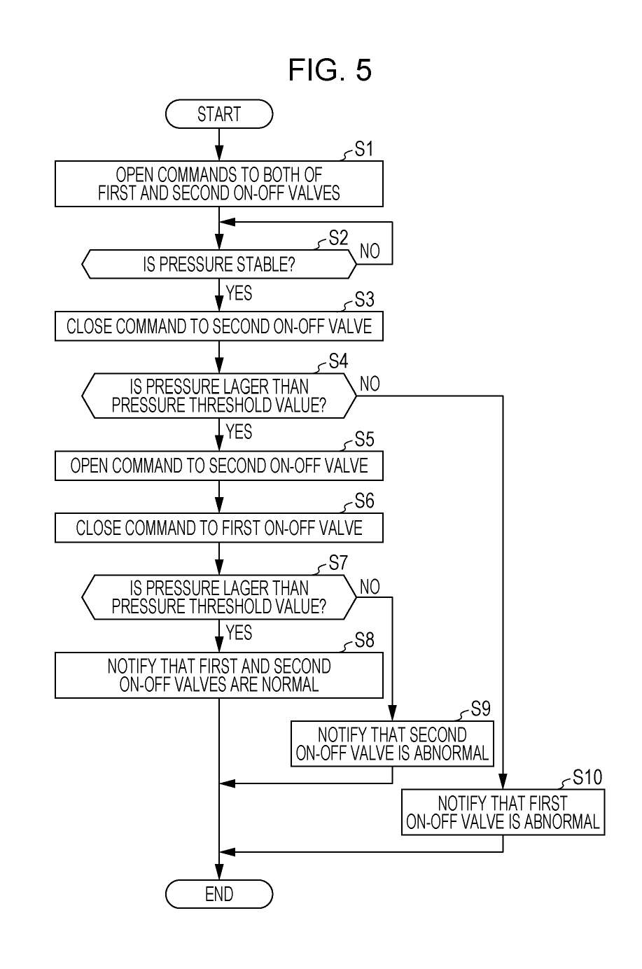

The present disclosure is basically configured as the above, and a process flow of the failure determination control will be described below with reference to FIG. 5.

The fuel cell system 10 executes and processes the determination processing program 80 to perform the failure determination control when the operation of the fuel cell vehicle is started or when the system is activated after the maintenance. Moreover, the pressure sensor 74 of the fuel cell system 10 is driven simultaneously when the system is activated, detects the real-time pressure in the junction pipe 56, and automatically transmits the detection signal S to the controller 16.

When the failure determination control is started, the controller 16 is sifted from a standby state to an operation mode during a gas supply period. When the gas supply period is started, the valve state setter 82 firstly outputs open commands Cₒ to both of the first and the second on-off valves 42 and 44 (Step S1) to allow the hydrogen gas to be supplied from the first and the second tanks 32 and 34.

Next, the pressure determiner 86 of the controller 16 monitors the pressure that is acquired by the pressure acquirer 84 from the pressure sensor 74, and determines whether the pressure becomes stable at a predetermined value (for example, 6 MPa) (Step S2). If the pressure changes (rises or the like), the process repeats Step S2, and if the pressure is stable at the predetermined value, the process proceeds to Step S3, and the controller 16 shifts to an operation mode during a primary determination period from the gas supply period.

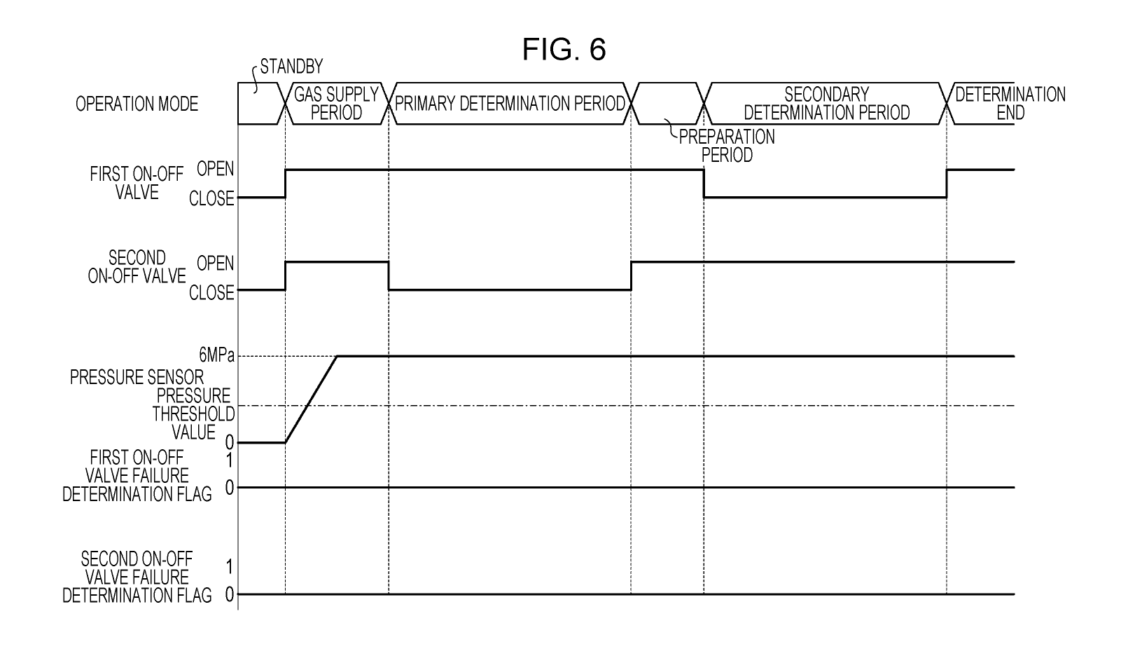

During the primary determination period, the controller 16 outputs a close command C_{c} to the second on-off valve 44 by the valve state setter 82 (Step S3), and temporarily stops the supply of the hydrogen gas from the second tank 34. The pressure determiner 86 then monitors the pressure acquired by the pressure acquirer 84 from the pressure sensor 74, and determines whether the pressure is lowered less than a predetermined pressure threshold value (see FIGS. 6 to 8) within a time range to some extent (Step S4). The pressure threshold value is preferably somewhat smaller than half of the predetermined value at which the pressure becomes stable, for example, in the abovementioned case where the predetermined value is 6 MPa, the pressure threshold value may preferably be around 2.5 MPa.

At Step S4, if the acquired pressure is more than the pressure threshold value, the pressure determiner 86 can determine that the hydrogen gas is supplied at least from the first tank 32, and the process proceeds to Step S5 in this case. In contrast, if the acquired pressure is equal to or less than the pressure threshold value, the pressure determiner 86 can determine that no hydrogen gas is supplied from the first tank 32, in other words, the first on-off valve 42 is abnormal, and the process proceeds to Step S10 in this case. This ends the operation mode during primary determination period.

At Step S5, the controller 16 shifts to an operation mode during a preparation period for a next secondary determination period, and outputs an open command Cₒ to the second on-off valve 44 by the valve state setter 82. This causes the second on-off valve 44 to open, and the junction pipe 56 can be again supplied with the hydrogen gas from both of the first and the second tanks 32 and 34.

Next, the controller 16 shifts to the operation mode during the secondary determination period, and the controller 16 outputs a close command C_{c} to the first on-off valve 42 by the valve state setter 82 (Step S6), and temporarily stops the supply of the hydrogen gas from the first tank 32. The pressure determiner 86 then monitors the pressure acquired by the pressure acquirer 84 from the pressure sensor 74, and determines whether the pressure is lowered less than a predetermined pressure threshold value within a time range to some extent (Step S7).

At Step S7, if the pressure to be acquired is more than the pressure threshold value, the pressure determiner 86 can determine that the hydrogen gas is supplied from the second tank 34, and the process proceeds to Step S8 in this case. In contrast, if the pressure is equal to or less than the pressure threshold value, the pressure determiner 86 can determine that no hydrogen gas is supplied from the second tank 34, in other words, the second on-off valve 44 is abnormal, and the process proceeds to Step S9 in this case. This ends the operation mode during the secondary determination period.

In the failure determination control, the controller 16 shifts to the operation mode of the end of determination at Steps S8, S9, and S10. For example, if YES at Step S7, the notifier 88 makes notification that the first and the second on-off valves 42 and 44 are normal at Step S8. If the first and the second on-off valves 42 and 44 are normal, no special notification may be required. In contrast, if NO at Step S7, the notifier 88 makes notification that the second on-off valve 44 has a closure failure at Step S9. Moreover, if NO at Step S4, the notifier 88 makes notification that the first on-off valve 42 has a closure failure.

When the flow in the foregoing is ended, the controller 16 ends the failure determination control of the first and the second on-off valves 42 and 44. Thereafter, for example, by using a state where the first and the second on-off valves 42 and 44 remain open, the hydrogen gas is continuously supplied to the fuel cell 12 to allow continuous power generation in the fuel cell 12. The abovementioned failure determination control may be performed while the fuel cell system 10 is operating or the activation of the fuel cell system 10 is stopped. Alternatively, when the fuel cell system 10 is subjected to a maintenance, the abovementioned failure determination control may be performed in such a manner that a diagnostic device or the like having a function similar to that of the controller 16 is connected thereto, and a command or a detection signal is transmitted from the outside of the system.

Hereinafter, the abovementioned failure determination control will be described in further details based on timing charts of cases (a cases where the first and the second on-off valves 42 and 44 are normal, a case where the second on-off valve 44 has a closure failure, and a case where the first on-off valve 42 has a closure failure) illustrated in FIGS. 6 to 8. In a case where both of the first and the second on-off valves 42 and 44 have failures, no hydrogen gas is supplied to the fuel cell 12 and the fuel cell system 10 is not activated primarily. This enables the fuel cell system 10 to determine the abnormality of the fuel gas supply device 14 (including the closure failures of the first and the second on-off valves 42 and 44) based on the activation failure of the system or the non-reaction of the pressure sensor 74.

In the case where both of the first and the second on-off valves 42 and 44 are normal, as illustrated in FIG. 6, during the gas supply period after the failure determination control is started, the first on-off valve 42 and the second on-off valve 44 are opened, so that hydrogen gas is supplied from both of the first and the second tanks 32 and 34. The pressure sensor 74 provided to the junction pipe 56 detects the pressure of the joined hydrogen gas, a value of the pressure rapidly increases. After a certain extent period of time has passed, the pressure becomes in a stable state at the predetermined pressure (6 MPa in the illustrated example) in accordance with the supply amount of hydrogen gas with respect to the fuel cell 12.

In the state where the pressure is stable, if the second on-off valve 44 is closed during the primary determination period, the first on-off valve 42 is opened. Therefore, the supply amount of the hydrogen gas from the first tank 32 increases, so that the predetermined pressure hardly changes. During the preparation period thereafter, the second on-off valve 44 is again opened, and both of the first and the second on-off valves 42 and 44 are in an open state similar to during the gas supply period. During a secondary determination period after the preparation period, while the first on-off valve 42 is closed, the second on-off valve 44 is opened. Therefore, the supply amount of the hydrogen gas from the second tank 34 increases, so that the predetermined pressure hardly changes.

Accordingly, the pressure determiner 86 can supply the hydrogen gas to the fuel cell 12 by opening the first on-off valve 42 after the determination end, without detecting that the pressure value becomes equal to or less than the threshold value during the determination period (in other words, determining that the first and the second on-off valves 42 and 44 are normal).

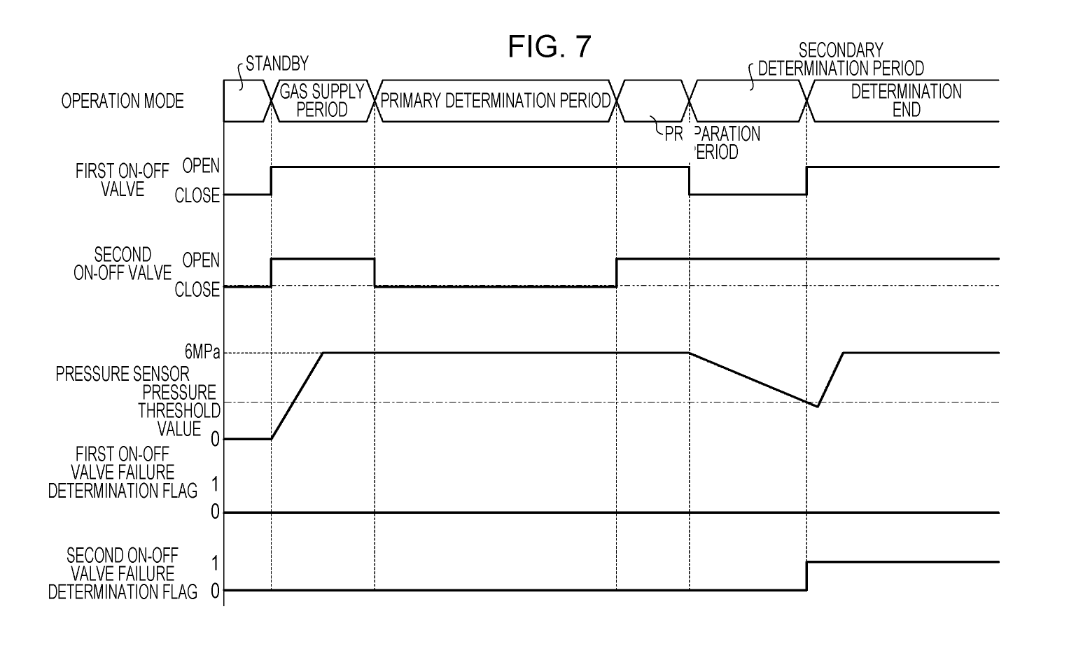

Moreover, in the case where the second on-off valve 44 has a failure, as illustrated in FIG. 7, although the valve state setter 82 issues an open command Cₒ and a close command C_{c} to the second on-off valve 44, the second on-off valve 44 is actually closed all the time as indicated by a chain double-dashed line in FIG. 7. In this case, the first on-off valve 42 is opened during the gas supply period, so that the hydrogen gas is supplied from the first tank 32, and the hydrogen gas becomes in a stable state at the predetermined pressure.

Further, during the primary determination period, only a close command C_{c} is outputted to the second on-off valve 44, so that the first on-off valve 42 is continuously opened and the pressure of the pressure sensor 74 does not change. However, during the secondary determination period, the first on-off valve 42 is closed, so that the pressure in the junction pipe 56 is rapidly lowered to be less than the pressure threshold value. With this, the pressure determiner 86 determines a closure failure of the second on-off valve 44, and sets a second on-off valve failure determination flag to 1. Moreover, at the stage when the pressure determiner 86 determines the failure of the second on-off valve 44, the valve state setter 82 promptly opens the first on-off valve 42 to restart the supply of the hydrogen gas, thereby preventing the operation of the fuel cell system 10 from being hindered.

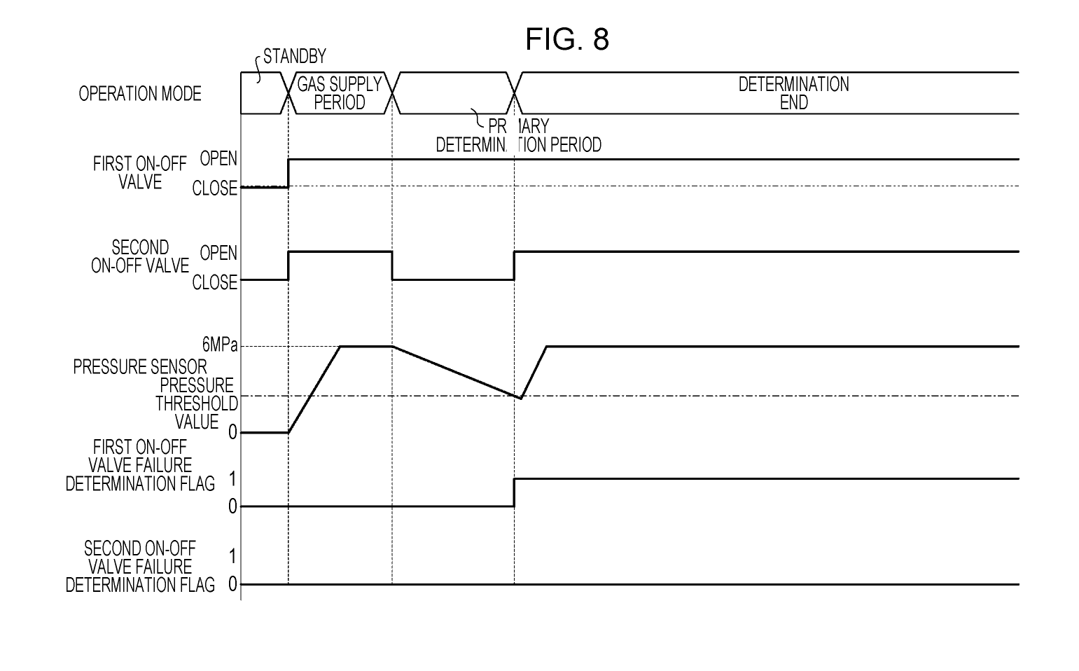

Moreover, in the case where the first on-off valve 42 has a failure, as illustrated in FIG. 8, although the valve state setter 82 issues an open command Cₒ and a close command C_{c} to the first on-off valve 42, the first on-off valve 42 is actually closed all the time as indicated by a chain double-dashed line in FIG. 8. In this case, the second on-off valve 44 is opened during the gas supply period, so that the hydrogen gas is supplied from the second tank 34, and the hydrogen gas becomes in a stable state at the predetermined pressure.

During the primary determination period, the second on-off valve 44 is closed, so that the pressure in the junction pipe 56 is rapidly lowered to be less than the pressure threshold value. With this, the pressure determiner 86 determines the failure (abnormality) of the first on-off valve 42, and sets a first on-off valve failure determination flag. Moreover, at a stage when determining the failure of the first on-off valve 42, the pressure determiner 86 can recognize that the second on-off valve 44 is normal, so that the failure determination control can shift to the determination end. As a result, the identification of the failures of the first and the second on-off valves 42 and 44 ends in a short period of time, so that the valve state setter 82 promptly can open the second on-off valve 44 and restart the supply of the hydrogen gas.

The controller 16 may preferably suspend or stop the control during when the failure determination control is executed based on various elements. Examples of the elements include a case where the pressure sensor 74 is unable to monitor the pressure (for example, a failure of the pressure sensor 74 or the tank 30, the communication abnormality), a case where the hydrogen gas does not become in a normal pressure state in the junction pipe 56 (for example, a failure of the pipe or the regulator), a case where the hydrogen gas is not normally consumed in the fuel cell 12, and the operation in the fuel cell system 10 cannot be ensured (for example, lowering of the power supply voltage).

As in the foregoing, the fuel cell system 10 according to the present embodiment can easily and accurately determine the normality of the first and the second on-off valves 42 and 44, or a failure of either of the first and the second on-off valves 42 and 44. In other words, the on-off valve 40 having a failure does not respond to an instruction to open or close for each on-off valve 40 from the controller 16 to change the pressure of the hydrogen gas flowed out from the tank 30, and the controller 16 can easily identify the failure of the on-off valve 40 by monitoring the pressure. This enables the fuel cell system 10 to improve the convenience of the system, such as achieving reduction in a difference from the actual condition when a driving range is calculated.

In this case, in the failure determination control, the valve state setter 82 of the controller 16 sequentially repeats to open any one on-off valve 40 out of the plurality of on-off valves 40, and to close the other on-off valves 40, so that it is possible to easily detect the on-off state of the one on-off valve 40. Moreover, after the first and the second on-off valves 42 and 44 are instructed to open when the failure determination control is started and the pressure detected by the pressure sensor 74 reaches a predetermined value, the respective on-off valves 40 are instructed to open and close, so that the fuel cell system 10 can perform the control and the determination while causing the fuel cell 12 to generate the power. Therefore, it is possible to secure the power necessary for the failure determination control, and reliably conduct the determination of failure. The fuel cell system 10 may use the power of a battery when the failure determination is performed. In this case, an open command is outputted to any one on-off valve 40 out of the plurality of on-off valves 40, the on-off valve 40 can be determined to be normal based on the pressure being raised detected by the pressure sensor 74, and the on-off valve 40 can be determined to have a closure failure based on the pressure being not changed.

Moreover, the controller 16 opens an on-off valve 40 having no failure to supply the hydrogen gas to the fuel cell 12 after the failure determination, so that it is possible to continue the generation of power by the fuel cell 12 as soon as possible. In other words, the normal hydrogen supply operation to the fuel cell 12 is immediately recovered to allow the fuel cell system 10 to be excellently operated and the convenience of the system to be further improved. In addition, at a stage when determining a failure of the on-off valve 40, the pressure determiner 86 does not determine a failure of the other on-off valves 40, the fuel cell system 10 can end the failure determination control in a short period of time. Accordingly, for example, the hydrogen gas is supplied immediately after the end of the failure determination control, so that it is possible to further excellently continue the generation of power by the fuel cell 12. In addition, the pressure determiner 86 performs a failure determination from the first on-off valve 42 of the first tank 32 having a large volumetric capacity, so that it is possible to detect the on-off valve that largely affects on the supply of the hydrogen gas at an early stage.

The present disclosure is not limited to the abovementioned embodiment, but it is needless to say that various modifications are possible within a range without deviating the scope of the present disclosure. For example, the fuel cell system 10 may be configured to manually open and close the first and the second on-off valves 42 and 44. In this case, the controller 16 (the valve state setter 82) can employ a method that performs a similar determination in such a manner that when the system is activated after the maintenance and others, notification that prompts a user to open and close the first and the second on-off valves 42 and 44 is made through the touch panel and others to cause the user to open and close the first and the second on-off valves 42 and 44.

Moreover, the fuel cell system 10 can detect, based on the pressure detected by the pressure sensor 74, not only closure failures of the plurality of on-off valves 40 but also open failures (failure in which the on-off valve is in a fixed state while remained open). For example, the controller 16 outputs close commands to the plurality of the on-off valves 40 when the fuel cell system 10 is stopped, and performs a control to drive the injector 58. With this, the injector 58 causes the hydrogen gas in the hydrogen gas supply pipe 50 to flow to the downstream side. Accordingly, the fuel cell system 10 can determine that the on-off valves 40 are normally closed if the pressure by the pressure sensor 74 is lowered, and can determine that the on-off valves 40 have open failures if the pressure by the pressure sensor 74 is not lowered.

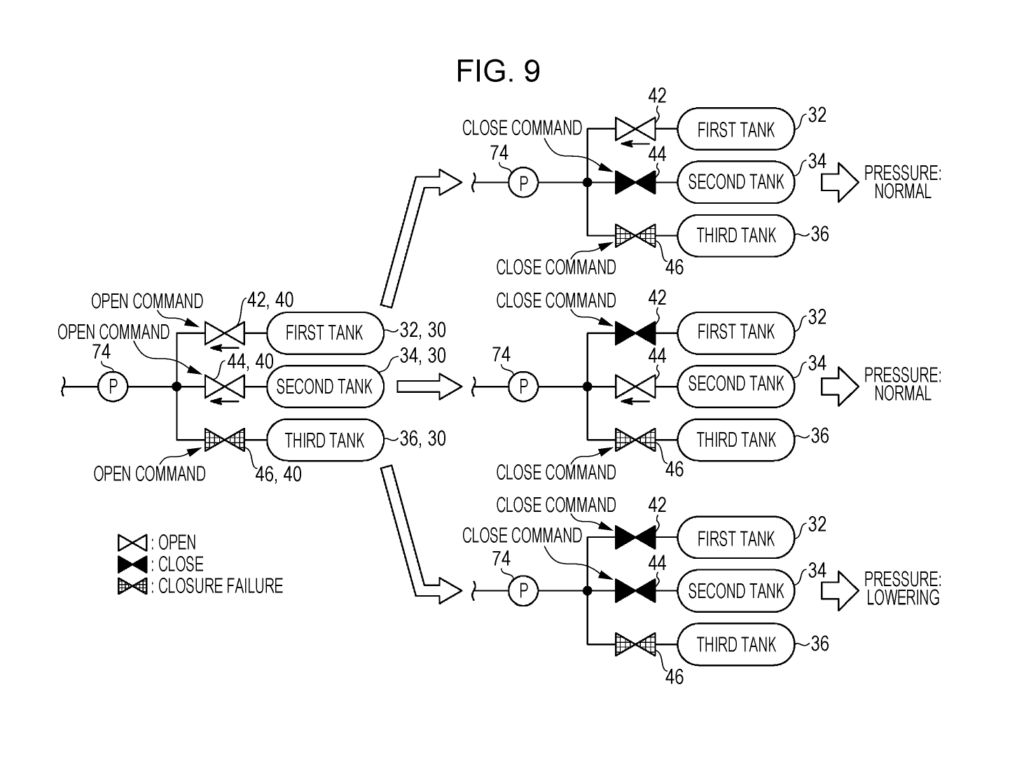

In addition, the fuel cell system 10 can configure a hydrogen supply source by not only two tanks 30 but also by three or more tanks 30. For example, as illustrated in FIG. 9, when the hydrogen supply source is configured by three tanks 30 (the first tank 32, the second tank 34, and a third tank 36), each tank includes three on-off valves 40 (the first on-off valve 42, the second on-off valve 44, and a third on-off valve 46). In this case, the fuel cell system 10 outputs close commands C_{c} to two of the on-off valves 40, outputs an open command Cₒ to one of the on-off valves 40, and successively changes the on-off valve 40 to be instructed, so that the fuel cell system 10 can detect the pressure lowering by the pressure sensor 74. As a result, the fuel cell system 10 can excellently identify the on-off valve 40 having a failure (the third on-off valve 46 in the third tank 36 in FIG. 9).

The present application describes a fuel cell system including a plurality of tanks, a plurality of on-off valves that are respectively connected to the plurality of tanks, each of the plurality of on-off valves allowing a reaction gas to flow out from the tank when being opened and preventing the reaction gas from flowing out from the tank when being closed, a flow path unit that causes the reaction gas flowed out from the plurality of tanks to join at a join point and to be supplied to a fuel cell, a pressure sensor that detects the pressure of the reaction gas at a downstream side of the join point of the flow path unit, and a controller that instructs opening or closing of the plurality of on-off valves. Here, the controller includes a determiner that determines whether any of the plurality of on-off valves has a failure, in a state where the opening or the closing is instructed for each of the plurality of on-off valves, based on a change in pressure acquired from the pressure sensor.

According to the above aspect, the fuel cell system can easily and accurately determine whether any of the plurality of on-off valves has a failure. In other words, an on-off valve having a failure does not respond to an open or close command for each on-off valve from the controller to change the pressure of the reaction gas, so that the controller can easily identify the failure of the on-off valve by monitoring the pressure. This enables the fuel cell system to reduce a difference from the actual condition in a calculation of a driving range when an on-off valve has a closure failure, for example, thereby making it possible to improve the convenience of the system.

In this case, the controller may perform a control in which opening any one on-off valve out of the plurality of on-off valves and closing the other on-off valve(s) are sequentially repeated, and the determiner may determine whether the one on-off valve has a failure based on a change in pressure in the control.

The controller performs a control in which opening any one on-off valve out of the plurality of on-off valves and closing the other on-off valve(s) are sequentially repeated in this manner, so that it is possible to easily detect whether one on-off valve follows a command of opening or closing depending on the change in pressure when the control is performed.

The controller may instruct opening of the plurality of on-off valves when the control is started, and instruct opening of the one on-off valve and closing the other on-off valve(s) after the pressure detected by the pressure sensor reaches a predetermined value.

Instructing opening of the plurality of on-off valves when the control is started, and instructing opening and closing of the respective on-off valves after the pressure reaches a predetermined value in this manner, so that the fuel cell system can perform the control and the determination while causing the fuel cell to generate the power. Therefore, it is possible to secure the power necessary for the control, and reliably conduct the determination of failure.

In addition to configuration described above, the determiner may have a pressure threshold value lower than the predetermined value, and determine a failure of the one on-off valve, based on the pressure being lowered less than the pressure threshold value when the control is performed.

The determiner determines a failure based on the pressure being lowered less than the pressure threshold value in this manner, so that the determiner can determine that the on-off valve is reliably closed.

When the determiner determines a failure of any of the plurality of on-off valves, the controller may open the on-off valve having no failure and supplies the reaction gas to the fuel cell.

The controller opens the on-off valve having no failure and supplies the reaction gas to the fuel cell after the determination of failure in this manner, so that it is possible to continue the generation of power by the fuel cell as soon as possible. As a result, it is possible to further improve the convenience of the system.

At a stage when determining a failure of any of the plurality of on-off valves, the determiner do not have to determine a failure of the other on-off valve(s).

This enables the fuel cell system to end the control in a short period of time, and to further excellently continue the generation of power by the fuel cell, by supplying a reaction gas immediately after the end of the control, for example.

The determiner may determine a failure of the on-off valve connected to the tank having the largest volumetric capacity, in descending order of the volumetric capacity of the plurality of tanks.

A failure of the on-off valve is determined in descending order of the volumetric capacity of the tanks in this manner, so that it is possible to detect the on-off valve that largely affects on the supply of the reaction gas at an early stage.

The present application describes a failure determination method of a fuel cell system, the fuel cell system including a plurality of tanks, a plurality of on-off valves that are respectively connected to the plurality of tanks, each of the plurality of on-off valves allowing a reaction gas to flow out from the tank when being opened and preventing the reaction gas from flowing out from the tank when being closed, a flow path unit that causes the reaction gas flowed out from the plurality of tanks to join at a join point and to be supplied to a fuel cell, and a pressure sensor that detects the pressure of the reaction gas at a downstream side of the join point of the flow path unit, and the failure determination method being for determining a failure of the plurality of on-off valves, and including the steps of instructing opening or closing of the plurality of on-off valves, by a controller, and determining whether any the plurality of on-off valves has a failure, based on a change in pressure acquired from the pressure sensor, by a determiner of the controller.

According to the present disclosure, a fuel cell system and a failure determination method of the fuel cell system easily and accurately determine whether any of a plurality of on-off valves has a failure, thereby improving the convenience of the system.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell system comprising:
a first tank to store a reaction gas;
a first pipe connected to the first tank;
a second tank to store the reaction gas;
a second pipe connected to the second tank;
a pipe connected to a fuel cell and connected to the first pipe and the second pipe at a joint point to supply the reaction gas from the first tank and the second tank to the fuel cell;
a first valve provided at the first pipe;
a second valve provided at the second pipe;
a pressure sensor provided at the pipe between the joint point and the fuel cell to detect a pressure of the reaction gas; and
circuitry configured to
control the first valve and the second valve; and
determine whether a failure occurs in at least one of the first valve and the second valve based on a change in the pressure detected by the pressure sensor while the first valve and the second valve are controlled.

2. The fuel cell system according to claim 1, wherein
the circuitry is configured to perform a control in which opening one valve out of the first valve and the second valve and closing an another valve out of the first valve and the second valve are sequentially repeated, and
the circuitry is configured to determine whether the one valve has the failure based on the change in the pressure in the control.

3. The fuel cell system according to claim 2, wherein
the circuitry is configured to instruct opening of the first valve and the second valve when the circuitry is started, and to instruct opening of the one valve and closing the another valve of the first valve and the second valve after the pressure detected by the pressure sensor reaches a predetermined value.

4. The fuel cell system according to claim 3, wherein
the circuitry is configured to have a pressure threshold value lower than the predetermined value, and to determine the failure of the one valve, based on the pressure being lowered less than the pressure threshold value when the circuitry is performed.

5. The fuel cell system according to claim 1, wherein
when the circuitry determines the failure of any of the first valve and the second valve, the circuitry opens a valve having no failure and supplies the reaction gas to the fuel cell.

6. The fuel cell system according to claim 1, wherein
at a stage when determining the failure of one valve of the first valve and the second valve, the circuitry does not determine the failure of an another valve of the first valve and the second valve.

7. The fuel cell system according to claim 6, wherein
the circuitry determines the failure of a valve connected to a tank having the largest volumetric capacity, in descending order of the volumetric capacity of the first tank and the second tank.

8. A failure determination method of a fuel cell system including a first tank to store a reaction gas, a first pipe connected to the first tank, a second tank to store the reaction gas, a second pipe connected to the second tank, a pipe connected to a fuel cell and connected to the first pipe and the second pipe at a joint point to supply the reaction gas from the first tank and the second tank to the fuel cell, a first valve provided at the first pipe, a second valve provided at the second pipe, and a pressure sensor provided at the pipe between the joint point and the fuel cell to detect a pressure of the reaction gas, the failure determination method comprising:
controlling the first valve and the second valve; and
determining whether a failure occurs in at least one of the first valve and the second valve based on a change in the pressure detected by the pressure sensor while the first valve and the second valve are controlled.

9. The failure determination method according to claim 8, further comprising:
controlling the first valve and the second valve such that opening one valve out of the first valve and the second valve and closing an another valve out of the first valve and the second valve are sequentially repeated; and
determining whether the one valve has the failure based on the change in the pressure in a control.

10. The failure determination method according to claim 9, further comprising:
opening the first valve and the second valve when a circuitry is started;
opening the one valve; and
closing the another valve after the pressure detected by the pressure sensor reaches a predetermined value.

11. The failure determination method according to claim 10, wherein
the circuitry is configured to have a pressure threshold value lower than the predetermined value, and
failure determination method further comprises determining the failure of the one valve, based on the pressure being lowered less than the pressure threshold value when the circuitry is performed.

12. The failure determination method according to claim 8, wherein when it is determined the failure of any of the first valve and the second valve, a valve having no failure is opened and the reaction gas is supplied to the fuel cell.

13. The failure determination method according to claim 8, further comprising not determining the failure of one valve among the first valve and the second valve at a stage when it is determined the failure of an another of the first valve and the second valve.

14. The fuel cell system according to claim 13, wherein it is determined the failure of a valve connected to a tank having the largest volumetric capacity, in descending order of the volumetric capacity of the first tank and the second tank.
